(19) United States
(12) Patent Application Publication
(10) Pub. No.: US 2017/0082063 A1
(43) Pub. Date: Mar. 23, 2017

(54) ENGINE NOZZLE SYSTEM FOR SHOCK-CELL NOISE REDUCTION

(71) Applicant: The Boeing Company, Chicago, IL (US)

(72) Inventor: Vinod Govind Mengle, Foothill Ranch, CA (US)

(21) Appl. No.: 15/369,879

(22) Filed: Dec. 5, 2016

Related U.S. Application Data
(63) Continuation-in-part of application No. 13/416,964, filed on Mar. 9, 2012, now Pat. No. 9,511,873.

(51) Int. Cl. F02K 1/48; F01D 25/24

(52) U.S. Cl. CPC F02K 1/48; F01D 25/24; F05D 2220/323; F05D 2260/96; F05D 2230/50

(57) ABSTRACT

A method and apparatus for reducing noise generated during operation of a propulsion system. In one illustrative embodiment, a nozzle system comprises a first nozzle and a second nozzle at least partially surrounded by the first nozzle. An outer surface of an aft portion of the second nozzle has a shape configured such that a radial cross-section of the outer surface of the aft portion of the second nozzle has a curve that is different from at least one other curve for another radial cross-section of the outer surface of the aft portion of the second nozzle and such that an axial cross-section of the outer surface of the aft portion of the second nozzle has a wavy shape.

### REFERENCE TO RELATED APPLICATIONS

This application is a continuation in part of application Ser. No. 13/416,964 filed on Sep. 03, 2012 entitled NOISE-REDUCING ENGINE NOZZLE SYSTEM, the disclosure of which is incorporated herein by reference.

### BACKGROUND INFORMATION

Field

The present disclosure relates generally to engines and, in particular, to a method and apparatus for reducing noise generated during operation of an engine. Still more particularly, the present disclosure relates to a method and apparatus for reducing noise generated by the shock cells created in the exhaust jet of an engine.

Background

An aircraft may generate different types of noise during different phases of flight. These different phases of flight may include taxiing, takeoff, landing, cruising, ascending, descending, and/or other phases of flight. In some cases, the noise generated by an aircraft may be undesirable to the passengers and/or crew onboard the aircraft. For example, noise generated during a cruise phase of flight may be undesirable to the passengers and/or crew of an aircraft.

One source of the noise generated during operation of an aircraft may be the operation of an engine of the aircraft. In particular, the flow of exhaust exiting an engine of an aircraft during operation of the engine may contribute to the undesirable noise produced during operation of an aircraft. The flow of exhaust exiting an engine is referred to as an exhaust jet. The exhaust jet is a stream of exhaust gases that flow out of the engine through a nozzle system for the engine. This stream of gases is used to move the aircraft. The pattern with which the exhaust jet flows out of the nozzle system may be referred to as an exhaust plume.

When the exhaust jet exits the nozzle system at supersonic speeds and when the exhaust jet exiting the nozzle has a pressure that is different from the pressure of the ambient air around the exhaust jet, a shock-cell pattern may form in the exhaust jet. This shock-cell pattern may be one factor that contributes to the noise generated during operation of an engine of an aircraft. The noise associated with this shock-cell pattern is referred to as shock-associated broadband noise or shock-cell noise.

A number of different mechanisms have been used to reduce the amount of noise generated during operation of an engine. These mechanisms include adding chevrons and/or serrations to one or more nozzles in the nozzle system for the engine. However, these currently available mechanisms for reducing the noise generated by an engine may not reduce the noise to within selected tolerances. In particular, currently available mechanisms may not reduce the shock-cell noise generated by an engine during a cruise phase of flight to within selected tolerances.

Therefore, it would be desirable to have a method and apparatus that takes into account one or more of the issues discussed above as well as possibly other issues.

### SUMMARY

The embodiments disclosed herein provide a method for shock cell noise reduction wherein the desired range of operating conditions is determined for an engine having a nozzle system with a fan nozzle and a core nozzle. For a core nozzle radius H1, a range of distances between exit planes, L, a range of annular radii H2 between the fan nozzle and core nozzle, is then established that provide cancellation of shock cells for the range of operating conditions. Curvature of a plurality of curves in a surface of the core nozzle is determined to provide the range of annular radii, H2. A trailing edge of the core nozzle is shaped using extensions to define the range of exit plane distances, L.

In one illustrative embodiment, a nozzle system for shock cell noise reduction incorporates a fan nozzle and a core nozzle concentric with the fan nozzle. The core nozzle has a plurality of curves in a surface of the core nozzle altering the effective annular radius between the fan nozzle and core nozzle, H2, over a first range. The core nozzle additionally has a plurality of circumferential extensions on a trailing edge of the core nozzle varying the distance, L, between an exit plane of the fan nozzle and an exit plane of the core nozzle between tips and roots of each extension over a second range. The first range of H2 and second range of L are determined to establish cancellation of shock cells for a range of operating conditions of an engine.

The features, functions, and benefits can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives, and features thereof will best be understood by reference to the following detailed description of an illustrative embodiment of the present disclosure when read in conjunction with the accompanying drawings, wherein:

FIG. 1 is an illustration of a nozzle system for an engine in accordance with an illustrative embodiment;

FIG. 2 is an illustration of a center axis for nozzle system and different axial planes and radial axes relative to the center axis in accordance with an illustrative embodiment;

FIG. 3 is an illustration of a shape for the outer surface of a nozzle in accordance with an illustrative embodiment;

FIG. 4 is an illustration of a perspective view of an engine for an aircraft in accordance with an illustrative embodiment;

FIG. 5 is an illustration of a perspective view of a core nozzle of a nozzle system in accordance with an illustrative embodiment;

FIG. 6 is an illustration of a side view of a core nozzle of a nozzle system in accordance with an illustrative embodiment;

FIG. 7 is an illustration of an end view of a core nozzle in accordance with an illustrative embodiment;

FIG. 8 is an illustration of axial slices through a core nozzle in accordance with an illustrative embodiment;

FIG. 9 is an illustration of a cross-sectional view of a core nozzle in accordance with an illustrative embodiment;

FIG. 10 is an illustration of another configuration for a core nozzle in accordance with an illustrative embodiment;

FIG. 11 is an illustration of a side view of a core nozzle in accordance with an illustrative embodiment;

FIG. 12 is an illustration of an end view of a core nozzle in accordance with an illustrative embodiment;

FIG. 13 is an illustration of a cross-sectional view of a core nozzle in accordance with an illustrative embodiment;

FIG. 14 is an illustration of a portion of a nozzle system in accordance with an illustrative embodiment;

FIG. 15 is an illustration of a portion of a nozzle system with a plug having a channel in accordance with an illustrative embodiment;

FIG. 16 is an illustration of a side view of a portion of a nozzle system with a plug having a channel in accordance with an illustrative embodiment;

FIG. 17 is an illustration of a portion of a nozzle system with a plug having a channel in accordance with an illustrative embodiment;

FIG. 18 is an illustration of a side view of a nozzle system with a plug having a channel in accordance with an illustrative embodiment;

FIG. 19 is an illustration of a portion of a nozzle system with a different type of plug in accordance with an illustrative embodiment;

FIG. 20 is an illustration of an aircraft in accordance with an illustrative embodiment;

FIG. 21 is an illustration of a process for reducing noise generated by an engine in the form of a flowchart in accordance with an illustrative embodiment;

FIG. 22A is a schematic representation showing shock generation from a concentric nozzle system;

FIG. 22B is a schematic representation of shock cancellation with adapted annular radius between the nozzles and radius of the inner nozzle and the distance between the exit planes of the two nozzles; and,

FIG. 23 is a flowchart depicting operation of a concentric nozzle system with varying annular radius, inner radius and length from the outer nozzle exit plane.

### DETAILED DESCRIPTION

The different illustrative embodiments recognize and take into account different considerations. For example, the different illustrative embodiments recognize and take into account that noise, including shock-cell noise, produced by an engine during operation of an aircraft may be undesirable. The noise produced by an engine of an aircraft may be undesirable to the passengers and/or crew onboard the aircraft while the aircraft is in flight.

The different illustrative embodiments recognize and take into account that it may be desirable to have a nozzle system that is configured to reduce noise, and in particular, shock-cell noise, to within selected tolerances. Thus, the different illustrative embodiments provide a method and apparatus for reducing noise generated during operation of a propulsion system.

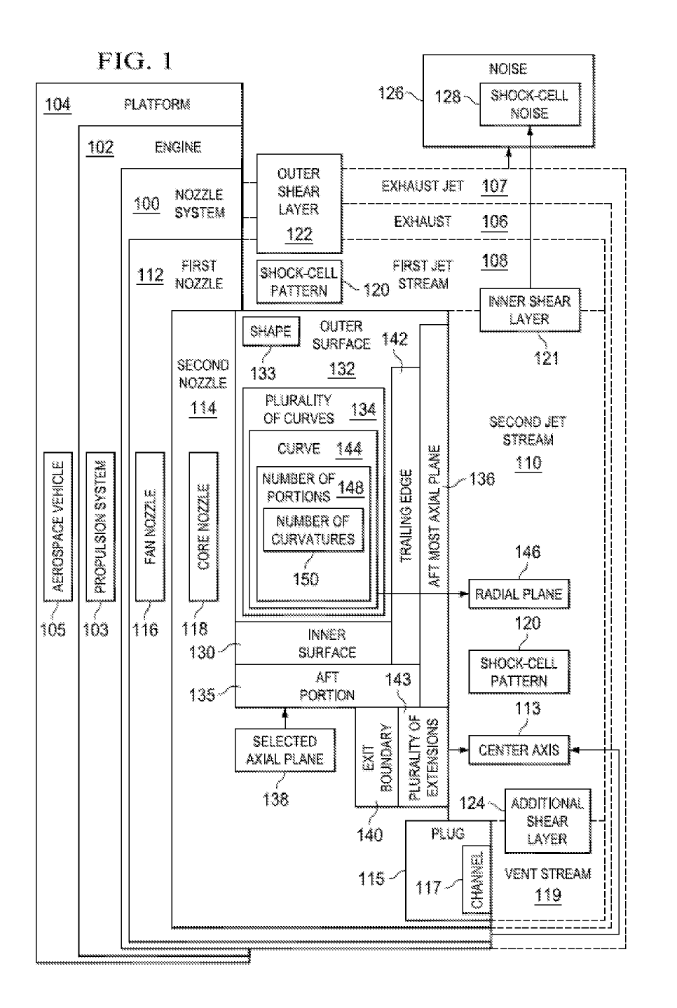

Referring now to the figures, and in particular, with reference to FIG. 1, an illustration of a nozzle system for an engine is depicted in the form of a block diagram in accordance with an illustrative embodiment. In these illustrative examples, nozzle system 100 is part of engine 102.

Engine 102 may be configured for use in platform 104. In these illustrative examples, platform 104 is aerospace vehicle 105. Aerospace vehicle 105 may be selected from one of an aircraft, a jet aircraft, a missile, a spacecraft, a space shuttle, or some other suitable type of vehicle configured for travel in air and/or space. Of course, in other illustrative examples, platform 104 may be some other suitable type of mobile platform configured to move using engine 102. In still other illustrative examples, engine 102 may be configured for use in a stationary platform. For example, engine 102 may be used in a power generation system.

As depicted, engine 102 may take the form of propulsion system 103 when platform 104 is aerospace vehicle 105. As used herein, a “propulsion system” is any system configured to produce thrust to push an object forward. For example, engine 102 may be a jet engine. More specifically, engine 102 may be a turbofan engine. Of course, in other illustrative examples, engine 102 may be a turbojet engine, a rocket engine, or some other suitable type of propulsion system for aerospace vehicle 105.

Propulsion system 103 is configured to generate and expel exhaust 106 through nozzle system 100 to generate the thrust needed to move platform 104. The flow of exhaust 106 exiting nozzle system 100 is exhaust jet 107 in these illustrative examples. The shape and/or pattern of exhaust jet 107 exiting nozzle system 100 may be referred to as the exhaust plume for propulsion system 103.

As depicted in these examples, exhaust jet 107 comprises first jet stream 108 and second jet stream 110 that exit propulsion system 103 through nozzle system 100 at substantially the same time. First jet stream 108 is a first flow of exhaust 106 that exits propulsion system 103 through first nozzle 112 of nozzle system 100. Second jet stream 110 is a second flow of exhaust 106 that exits propulsion system 103 through second nozzle 114 of nozzle system 100.

In these illustrative examples, first nozzle 112 may be fan nozzle 116. Further, second nozzle 114 may be core nozzle 118 in these examples. In some cases, second nozzle 114 may be referred to as a primary nozzle, while first nozzle 112 may be referred to as a secondary nozzle. In still other illustrative examples, first nozzle 112 may be fan nozzle 116, while second nozzle 114 may be a vent nozzle associated with a core nozzle. This vent nozzle may be referred to as a tertiary nozzle or a tertiary vent nozzle.

First nozzle 112 at least partially surrounds second nozzle 114. In other words, second nozzle 114 may be located within first nozzle 112. In one illustrative example, second nozzle 114 is nested within first nozzle 112. In other words, first nozzle 112 and second nozzle 114 may be substantially concentric to each other. For example, center axis 113 may be a center axis for both first nozzle 112 and second nozzle 114. Of course, in other illustrative examples, center axis 113 may only be a center axis for second nozzle 114, and first nozzle 112 may have a different center axis substantially parallel to but offset from center axis 113.

Depending on the implementation, first nozzle 112 may extend downstream of second nozzle 114 or second nozzle 114 may extend downstream of first nozzle 112. When platform 104 is aerospace vehicle 105, “downstream”, as used herein, is towards an aft end of aerospace vehicle 105. As used herein, “upstream” is towards a forward end of aerospace vehicle 105.

In some illustrative examples, nozzle system 100 may include plug 115 in addition to first nozzle 112 and second nozzle 114. When nozzle system 100 includes plug 115, plug 115 is nested within second nozzle 114. In other words, plug 115 may share center axis 113 with first nozzle 112 and second nozzle 114. Of course, in other illustrative examples, plug 115 may have a different center axis that is substantially parallel to but offset from center axis 113.

Depending on the implementation, plug 115 may have channel 117. Channel 117 may be present in plug 115 to vent gases generated by propulsion system 103. This flow of gases exiting channel 117 in plug 115 is vent stream 119.

In these illustrative examples, with second nozzle 114 located within first nozzle 112, second jet stream 110 is surrounded by first jet stream 108 as these two jet streams exit nozzle system 100 Inner shear layer 121 is formed at the interface between first jet stream 108 and second jet stream 110. Outer shear layer 122 is formed at the interface between first jet stream 108 and the air around exhaust jet 107. In some cases, outer shear layer 122 may be at least partially formed by a mixture of first jet stream 108 and second jet stream 110, as well as the air around exhaust jet 107. Further, when nozzle system 100 includes plug 115 and plug 115 includes channel 117, additional shear layer 124 is formed between first jet stream 108 and vent stream 119.

During operation of propulsion system 103, first jet stream 108 and/or second jet stream 110 may exit nozzle system 100 at speeds greater than the speed of sound. At supersonic speeds, shock-cell pattern 120 may form within first jet stream 108 and/or second jet stream 110. Shock-cell pattern 120 comprises shock-cells, also referred to as shock diamonds or shock-cell diamonds, within exhaust jet 107 that may be visible. Shock-cells or shock-cell diamonds are a formation of stationary wave patterns that appear in a jet stream.

Shock-cell pattern 120 is formed when a jet stream that exits nozzle system 100 is supersonic and is either over-expanded or under-expanded. The jet stream is over-expanded when the static pressure of the jet stream exiting a nozzle is less than the static pressure of the flow of air and/or exhaust surrounding that jet stream. The jet stream is under-expanded when the pressure of the jet stream exiting the nozzle is greater than the pressure of the flow of air and/or exhaust surrounding that jet stream. Typically, a jet stream may be under-expanded at cruise conditions at high altitudes.

When a jet stream is either over-expanded or under-expanded, the pressure in the jet stream where the jet stream exits nozzle system 100 begins either compressing or expanding. When the jet stream is first jet stream 108, compression or expansion waves are formed that reflect between outer shear layer 122 and inner shear layer 121 in a manner that causes shock-cells to form in first jet stream 108. When second jet stream 110 encounters a similar situation, shock-cells are formed in second jet stream 110.

When shock-cell pattern 120 is formed within first jet stream 108 and/or second jet stream 110, noise 126 generated during operation of propulsion system 120 includes shock-cell noise 128. Noise 126 is the noise associated with the flow of exhaust 106 from nozzle system 100. In other words, noise 126 is the noise associated with exhaust jet 107 exiting nozzle system 100. In some illustrative examples, shock-cell noise 128 also may be referred to as shock-associated broadband noise.

Nozzle system 100 is configured to reduce noise 126, and in particular, shock-cell noise 128, to within selected tolerances. As one illustrative example, second nozzle 114 of nozzle system 100 is configured to reduce shock-cell noise 128 generated during a cruise phase of flight for aerospace vehicle 105 to within selected tolerances. Of course, in other illustrative examples, nozzle system 100 may be configured to reduce shock-cell noise 128 generated during other phases of flight.

As depicted in FIG. 1, second nozzle 114 has inner surface 130 and outer surface 132. Further, in these illustrative examples, second nozzle 114 includes plurality of extensions 143 configured to extend aftwards from exit boundary 140 along outer surface 132. Each extension in plurality of extensions 143 may have a base that lies along exit boundary 140 of outer surface 132 and a tip located downstream of exit boundary 140.

Plurality of extensions 143 may be referred to as, for example, without limitation, serrations or chevrons. Depending on the implementation, these extensions may have a trapezoidal shape, a triangular shape, or some other suitable type of shape. Plurality of extensions 143 may be configured to reduce noise 126.

In these illustrative examples, plurality of extensions 143 may be part of aft portion 135 of second nozzle 114. Aft portion 135 of second nozzle 114 is the portion of second nozzle 114 between selected axial plane 138 through second nozzle 114 and aftmost axial plane 136 through second nozzle 114. As used herein, an “axial plane” through second nozzle 114, such as aftmost axial plane 136 or selected axial plane 138, is a plane through second nozzle 114 that is substantially perpendicular to center axis 113 through second nozzle 114.

Selected axial plane 138 may be any axial plane through second nozzle 114 that is located upstream of plurality of extensions 143. In other words, none of the extensions in plurality of extensions 143 may have a portion located upstream of selected axial plane 138. In some cases, exit boundary 140 from which plurality of extensions 143 extend may be contained within a single axial plane through second nozzle 114. In other illustrative examples, exit boundary 140 may span more than one axial plane through second nozzle 114.

Aftmost axial plane 136 is the axial plane through second nozzle 114 located at the aftmost portion of trailing edge 142 of second nozzle 114. Trailing edge 142 is the aft edge where second nozzle 114 ends. At least a portion of trailing edge 142 is formed by the aft edges of the extensions in plurality of extensions 143. Aftmost axial plane 136 may be the axial plane through the aftmost tip of the tips of plurality of extensions 143.

In these illustrative examples, outer surface 132 of aft portion 135 of second nozzle 114 has shape 133 configured to reduce shock-cell noise 128. In particular, shape 133 of the portion of outer surface 132 between selected axial plane 138 and aftmost axial plane 136 is configured such that a radial cross-section of this portion of outer surface 132 through second nozzle 114 is curved.

As used herein, “radial cross-section” through second nozzle 114 is a cross-section through a radial plane through second nozzle 114. Further, a “radial plane” through second nozzle 114, as used herein, is any plane through second nozzle 114 that includes center axis 113. In other words, a radial plane is a plane in which center axis 113 lies.

In these illustrative examples, shape 133 is configured such that a radial cross-section of the portion of outer surface 132 between selected axial plane 138 and aftmost axial plane 136 has a curve that is different from at least one other curve for another radial cross-section of the portion of outer surface 132 between selected axial plane 138 and aftmost axial plane 136.

In this manner, shape 133 of the portion of outer surface 132 within aft portion 135 of second nozzle 114 is configured such that different radial cross-sections of this portion of outer surface 132 may have different curves. Further, in these illustrative examples, any radial cross-section of the portion of outer surface 132 located upstream of selected axial plane 138 of second nozzle 114 may not be curved. Instead, this radial cross-section may be substantially linear.

An “axial cross-section” through second nozzle 114, as used herein, is a cross-section through an axial plane through second nozzle 114. When second nozzle 114 has plurality of extensions 143, axial cross-sections of outer surface 132 of second nozzle 114 at and upstream of exit boundary 140 are continuous. Further, axial cross-sections of outer surface 132 of second nozzle 114 downstream of exit boundary 140 may be discontinuous.

In these illustrative examples, shape 133 of the portion of outer surface 132 of second nozzle 114 between selected axial plane 138 and trailing edge 142 causes different axial cross-sections of outer surface 132 through aft portion 135 of second nozzle 114 to be non-circular, and in some cases, non-symmetrical. In particular, an axial cross-section of outer surface 132 along an axial plane between selected axial plane 138 and trailing edge 142 may be non-axisymmetrical. Shape 133 is configured such that the axial cross-section of outer surface 132 along an axial plane between selected axial plane 138 and aftmost axial plane 136 has a wavy shape.

In particular, the axial cross-section of outer surface 132 between selected axial plane 138 and aftmost axial plane 136 may be a wavy shape comprising at least one of hills and valleys with respect to center axis 113 through second nozzle 114. In other words, the axial cross-section of outer surface 132 may have a wavy shape that comprises hills, valleys, or a combination of the two when viewed from center axis 113.

When the axial cross-section of outer surface 132 of aft portion 135 of second nozzle 114 is taken along an axial plane downstream of the most forward portion of exit boundary 140, the wavy shape may be discontinuous. Depending on the implementation, only hills or only valleys may be seen with this type of axial cross-section.

Curve 144 is an example of a curve for a radial cross-section of outer surface 132 of aft portion 135 of second nozzle 114. In these illustrative examples, curve 144 is for the radial cross-section of outer surface 132 of aft portion 135 of second nozzle 114 along radial plane 146. Curve 144 begins at selected axial plane 138 and ends at trailing edge 142.

Curve 144 may have number of portions 148 with number of curvatures 150. As used herein, a “number of” items means one or more items. For example, number of portions 148 means one or more portions. Each portion in number of portions 148 has a corresponding curvature in number of curvatures 150.

As used herein, a “curvature” of a curve, such as curve 144, at any point, P, along curve 144 is defined as the reciprocal of the radius of the circle that most closely approximates curve 144 at or near that point, P. This circle may be referred to as an “osculating circle.” The curvature of this point, P, is the rate of change of the angle of the tangent at the point, P, on curve 144 per unit length of curve 144.

When the osculating circle tangential to the point, P, along curve 144 is located on the side of curve 144 facing center axis 113, the curvature at this point, P, may be referred to as being “convex,” with respect to the flow over outer surface 132. When the osculating circle tangential to the point, P, along curve 144 is located on the side of curve 144 facing first nozzle 112, the curvature at this point, P, may be referred to as being “concave,” with respect to the flow over outer surface 132. In this manner, the different curvatures along curve 144 may be concave curvatures, convex curvatures, or some combination of the two.

In one illustrative example, the curvature at all points along curve 144 may be the same. In another illustrative example, the curvature at different points along curve 144 may be different. In some cases, the curvature along curve 144 may continuously change between selected axial plane 138 and trailing edge 142. In this manner, shape 133 for outer surface 132 of aft portion 135 of second nozzle 114 may take a number of different forms, depending on the implementation.

In the different illustrative examples, shape 133 formed by the different curvatures selected for the different curves for outer surface 132 of aft portion 135 of second nozzle 114 are selected to reduce shock-cell noise 128 to within selected tolerances. In particular, when platform 104 is aerospace vehicle 105, shape 133 may be selected to reduce shock-cell noise 128 associated with shock-cell pattern 120 in first jet stream 108 and/or second jet stream 110 to within selected tolerances during a cruise phase of flight and/or other phases of flight for aerospace vehicle 105.

In some illustrative examples, an outer surface of an aft portion of first nozzle 112 may have a shape configured similar to shape 133 of outer surface 132 of aft portion 135 of second nozzle 114. This shape may be configured to reduce shock-cell noise 128 if shock-cells are formed in the air around first jet stream 108 when aerospace vehicle 105 is travelling at supersonic speeds.

For example, first nozzle 112 may have a plurality of extensions. When first nozzle 112 has the plurality of extensions, the shape of the outer surface of an aft portion of first nozzle 112 may be configured such that a particular curve for a radial cross-section of the outer surface of first nozzle 112 through first nozzle 112 is different from a curve for at least one other radial cross-section of the outer surface of first nozzle 112.

In still other illustrative examples, when nozzle system 100 includes plug 115 with channel 117, an outer surface of an aft portion of plug 115 may have a shape similar to shape 133 of outer surface 132 of aft portion 135 of second nozzle 114. This shape may be configured to reduce shock-cell noise 128 associated with second jet stream 110.

For example, plug 115 may have a plurality of extensions. When plug 115 has the plurality of extensions, the shape of the outer surface of an aft portion of plug 115 may be configured such that a particular curve for a radial cross-section of the outer surface of plug 115 through plug 115 is different from a curve for at least one other radial cross-section of the outer surface of plug 115.

In this manner, the shapes of the outer surfaces of the different nozzles in nozzle system 100 may be configured in a number of different ways to reduce shock-cell noise 128 to within selected tolerances. In particular, the outer surface of the aft portion of at least one of first nozzle 112, second nozzle 114, and plug 115 may have a shape configured to reduce shock-cell noise 128.

The illustration of nozzle system 100 in FIG. 1 is not meant to imply physical or architectural limitations to the manner in which an illustrative embodiment may be implemented. Other components in addition to and/or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, in some illustrative examples, nozzle system 100 may not include plug 115. In other illustrative examples, second nozzle 114 may not have plurality of extensions 143. In some cases, the different extensions in plurality of extensions 143 may have different lengths taken from the base to the tip of an extension.

In other illustrative examples, a third nozzle may be associated with second nozzle 114. This third nozzle may be a vent nozzle associated with outer surface 132 of second nozzle 114. Depending on the implementation, an outer surface of an aft portion of this third nozzle may have a shape configured similar to shape 133 for outer surface 132 of aft portion 135 of second nozzle 115. The shape of the outer surface of the aft portion of this third nozzle may be configured to help reduce shock-cell noise 128.

In some cases, different curves for outer surface 132 of aft portion 135 of second nozzle 114 along different radial planes through second nozzle 114 may begin at different selected axial planes through second nozzle. For example, in one illustrative example, one curve may begin at selected axial plane 138 and another curve may begin at an axial plane located downstream of selected axial plane 138.

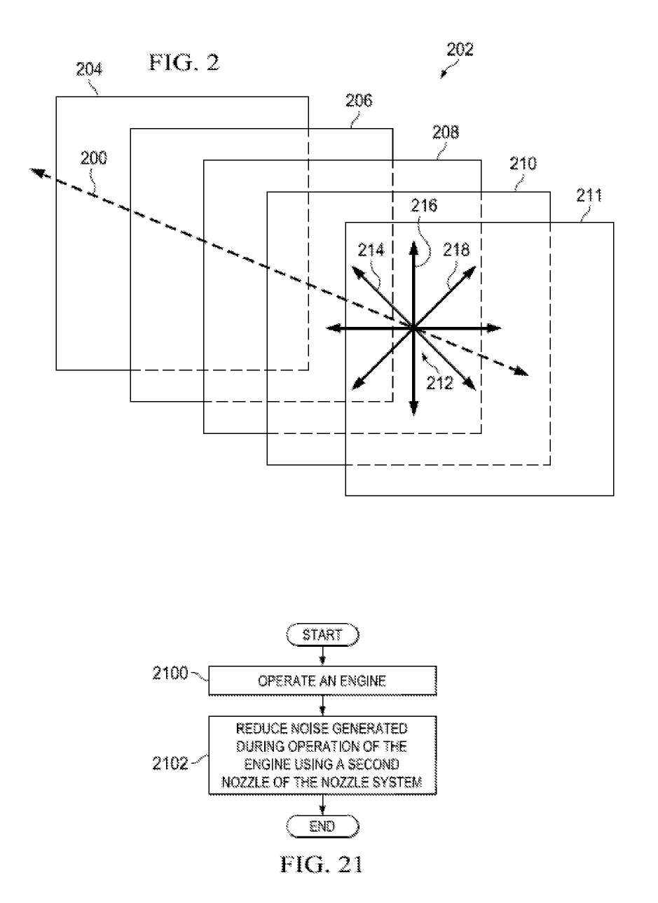

With reference now to FIG. 2, an illustration of a center axis for nozzle system and different axial planes and radial axes relative to the center axis is depicted in accordance with an illustrative embodiment. In this depicted example, center axis 200 is an example of center axis 113 in FIG. 1. In this manner, center axis 200 may be a center axis for nozzle system 100 in FIG. 1. For example, first nozzle 112, second nozzle 114, and plug 115 in FIG. 1 may be substantially concentric to each other with respect to center axis 113.

Axial planes 202 are planes perpendicular to center axis 200. Axial planes 202 include axial plane 204, axial plane 206, axial plane 208, axial plane 210, and axial plane 211. Axial plane 204 may be an example of selected axial plane 138 in FIG. 1. Axial plane 211 may be an example of aftmost axial plane 136 in FIG. 1. In one illustrative example, exit boundary 140 in FIG. 1 may be contained within axial plane 210.

Axial cross-sections of outer surface 132 of aft portion 135 of second nozzle 114 in FIG. 1 taken along axial planes 202 may appear non-circular and non-symmetrical when outer surface 132 of aft portion 135 of second nozzle 114 has shape 133 in FIG. 1. However, axial cross-sections of outer surface 132 of second nozzle 114 in FIG. 1 taken along any axial planes through second nozzle 114 upstream of axial plane 204 may appear substantially circular and symmetrical.

As depicted, radial axes 212 are axes that intersect center axis 200. Radial axes 212 include radial axis 214, radial axis 216, and radial axis 218. The plane formed by one of these radial axis and center axis 200 is referred to as a radial plane. For example, the plane formed by radial axis 214 and center axis 200 is an example of one implementation for radial plane 146 in FIG. 1.

When outer surface 132 of aft portion 135 of second nozzle 114 has shape 133 in FIG. 1, the radial cross-sections of outer surface 132 of aft portion 135 may have different curves. For example, the radial cross-section of outer surface 132 of aft portion 135 of second nozzle 114 taken along the radial plane formed by radial axis 214 and center axis 200 may have a curve that is different from the curve for the radial cross-section of outer surface 132 of aft portion 135 of second nozzle 114 along the radial plane formed by radial axis 216 and center axis 200.

In other illustrative examples, axial planes 202 and the radial planes formed by radial axes 212 and center axis 200 may be for first nozzle 112 in FIG. 1. In still other illustrative examples, axial planes 202 and the radial planes formed by radial axes 212 and center axis 200 may be for a plug, such as plug 115 in FIG. 1, instead of a nozzle.

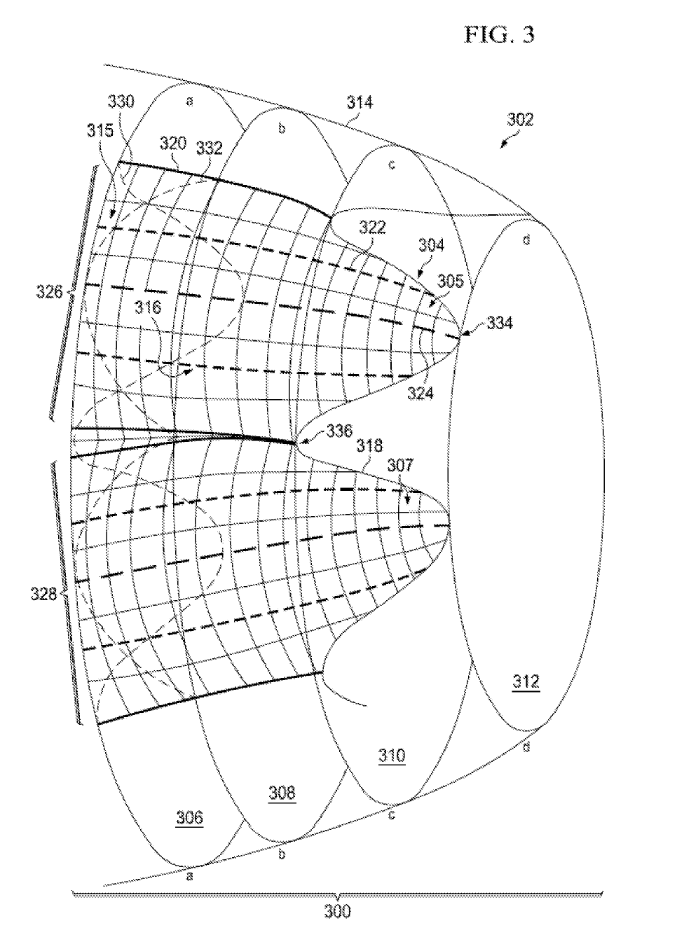

Turning now to FIG. 3, an illustration of a shape for the outer surface of a nozzle is depicted in accordance with an illustrative embodiment. In this illustrative example, aft portion 300 of core nozzle 302 is a representation of one example of an implementation for aft portion 135 of core nozzle 118 in FIG. 1. As depicted, core nozzle 302 has plurality of extensions 304. Plurality of extensions 304 includes extension 305 and extension 307.

Axial plane 306, axial plane 308, axial plane 310, and axial plane 312 are axial planes through aft portion 300 of nozzle 302. Axial plane 306 is an example of selected axial plane 138 in FIG. 1. Axial plane 312 is an example of aftmost axial plane 138 in FIG. 1. Aft portion 300 of core nozzle 302 is the portion of core nozzle 302 between axial plane 306 and axial plane 312.

In this illustrative example, outer surface 314 of aft portion 300 of core nozzle 302 has shape 315. Shape 315 is configured such that different radial cross-sections of outer surface 314 have different curves. In this illustrative example, shape 315 is configured such that portion 326 of outer surface 314 has substantially the same shape as portion 328 of outer surface 314.

Curves 316 are examples of curves for outer surface 314 of aft portion 300 of core nozzle 302 along different radial planes through core nozzle 302. As depicted in this example, all of curves 316 for outer surface 314 begin at axial plane 306 and end at trailing edge 318 of core nozzle 302. Curve 320, curve 322, and curve 324 are examples of curves 316. These three curves lie along different radial planes through core nozzle 302.

In this illustrative example, the different curvatures along the different curves for the portion of outer surface 314 at and near tip 334 of extension 305 are selected such that an axial cross-section of this portion of outer surface 314 at and near tip 334 of extension 336 appears as a hill. Further, the different curvatures along the different curves for the portion of outer surface 314 at and near interface 336 between extension 305 and extension 307 are selected such that an axial cross-section of this portion of outer surface 314 at and near interface appears 336 as a valley.

In this illustrative example, shape 315 is configured such that the curvature along a curve in curves 316 is different from the curvature along other curves in curves 316 beginning at axial plane 306. However, in other illustrative examples, outer surface 314 of aft portion 300 of core nozzle 314 may have a shape configured such that all curves along all radial planes through core nozzle 302 have the same selected curvature between axial plane 306 and boundary 330. In other words, in these other illustrative examples, outer surface 314 of aft portion 300 may have a shape configured such that the curvatures along curve 320, curve 322, and curve 324 are the same up until boundary 330 and different downstream of boundary 330 up until trailing edge 318.

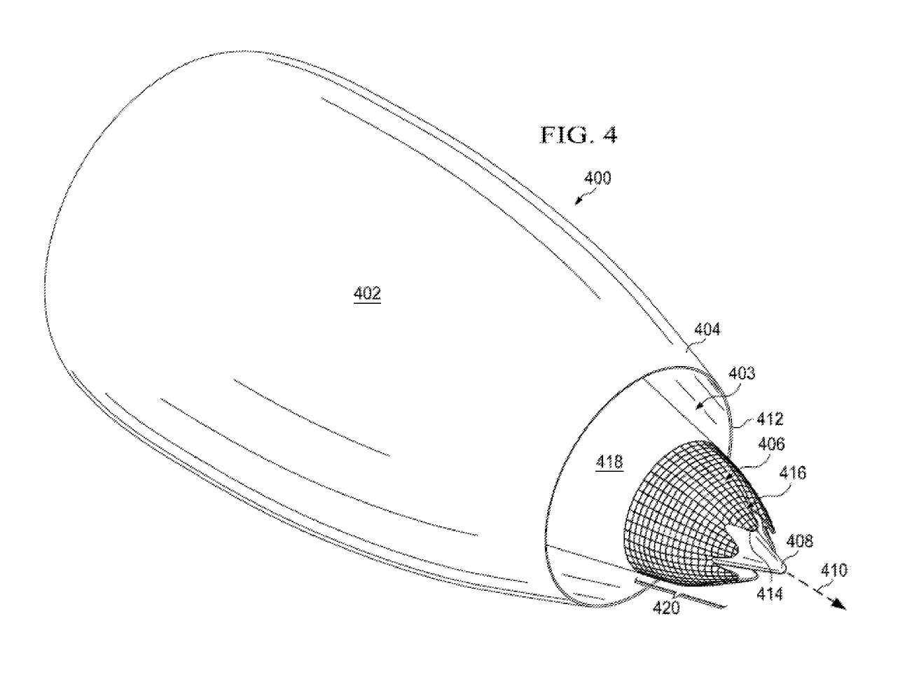

In still other illustrative examples, outer surface 314 of aft portion 300 of core nozzle 314 may have a shape configured such that all curves along all radial planes through core nozzle 302 have the same selected curvature between axial plane 306 and boundary 332. In other words, in these other illustrative examples, outer surface 314 of aft portion 300 may have a shape configured such that the curvatures along curve 320, curve 322, and curve 324 are the same up until boundary 332 and different downstream of boundary 330 up until trailing edge 318. With reference now to FIGS. 4-20, illustrations of different configurations for a nozzle system for an engine are depicted in accordance with an illustrative embodiment. Engine 400 in FIGS. 4-20 may be implemented in an aerospace vehicle, such as aerospace vehicle 105 in FIG. 1. Engine 400 may be an example of engine 102 in FIG. 1. In particular, engine 400 may be implemented in a jet aircraft. In these illustrative examples, engine 400 is a turbofan engine. The different configurations for nozzle system 400 for engine 400 are selected to reduce noise generated by engine 400 during operation of engine 400. More specifically, these different configurations for nozzle system 403 are selected to reduce shock-cell noise.

Turning now to FIG. 4, an illustration of a perspective view of an engine for an aircraft is depicted in accordance with an illustrative embodiment. In this illustrative example, engine 400 includes nacelle 402 and nozzle system 403. Nacelle 402 is a housing for engine 400. Nozzle system 403 is an example of one implementation for nozzle system 100 in FIG. 1. Nozzle system 403 is located at an aft end of nacelle 402.

Nozzle system 403 includes fan nozzle 404, core nozzle 406, and plug 408. Fan nozzle 404 is an example of one implementation for fan nozzle 112 in FIG. 1. Core nozzle 406 is an example of one implementation for core nozzle 114 in FIG. 1. Further, plug 408 is an example of one implementation for plug 115 in FIG. 1. As depicted, plug 408 has a conical shape in this example.

Fan nozzle 404 and core nozzle 406 allow exhaust generated during operation of engine 400 to exit engine 400 in the form an exhaust jet. In this illustrative example, core nozzle 406 is nested within fan nozzle 404. Plug 408 is nested within core nozzle 406.

As depicted, plug 408, core nozzle 406, and fan nozzle 404 share center axis 410. Of course, in other illustrative examples, the center axis for plug 408, core nozzle 406, and fan nozzle 404 may be substantially parallel but offset from each other.

Fan nozzle 404 has trailing edge 412. Further, core nozzle 406 has trailing edge 414 formed by plurality of extensions 416. Plurality of extensions 416 are an example of one implementation for plurality of extensions 53 in FIG. 1. Plurality of extensions 416 may also be referred to as a plurality of chevrons or a plurality of serrations in some cases.

Core nozzle 406 has outer surface 418. The shape of outer surface 418 of aft portion 420 of core nozzle 406 is configured such that outer surface 418 of aft portion 420 is curved. The shape of outer surface 418 is described in greater detail in the figures below.

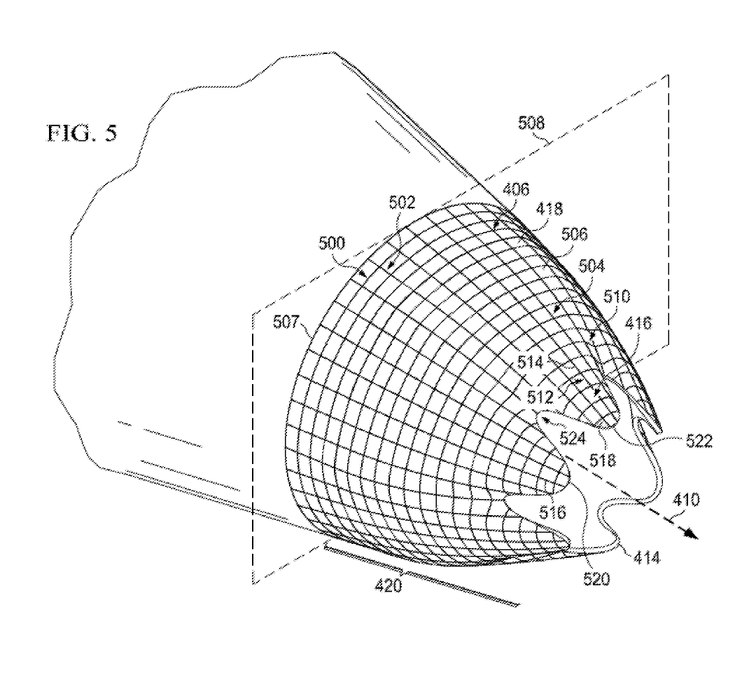

Turning now to FIG. 5, an illustration of a perspective view of core nozzle 406 of nozzle system 403 is depicted in accordance with an illustrative embodiment. An enlarged view of core nozzle 406 from FIG. 4 is depicted in FIG. 5. In this illustrative example, azimuthal lines 500 and longitudinal lines 502 on outer surface 418 of core nozzle 406 are contour lines that indicate the shape of outer surface 418 of aft portion 420 of core nozzle 406.

Azimuthal lines 500 lie along axial planes through core nozzle 406. Longitudinal lines 502 lie along radial planes through core nozzle 406. As depicted, outer surface 418 of aft portion 420 of core nozzle 406 is curved. For example, outer surface 418 has plurality of curves 504 that lie along a plurality of radial planes through center axis 410.

The shape of outer surface 418 formed by plurality of curves 504 is indicated by longitudinal lines 502 depicted on outer surface 418. For example, longitudinal line 506 indicates the shape of curve 510 of outer surface 418 beginning at selected axial plane 508 and ending at trailing edge 414. Selected axial plane 508 coincides with azimuthal line 507 in this example. In this illustrative example, all of the curves in plurality of curves 504 begin at selected axial plane 508 and end at trailing edge 414 of core nozzle 406.

The curvature along each curve in plurality of curves 504 change along the direction of center axis 410. For example, the curvature along curve 510 may be greater closer to trailing edge 418 as compared to the curvature of curve 510 closer to selected axial plane 508. Further, as depicted, the curvature of curve 510 near trailing edge 418 may be greater than the curvature of curve 512 indicated by longitudinal line 514 near trailing edge 418.

In this illustrative example, plurality of extensions 416 includes extension 516 and extension 518. Extension 516 has tip 520 and extension 518 has tip 522. Root 524 is located at the interface between extension 516 and extension 518.

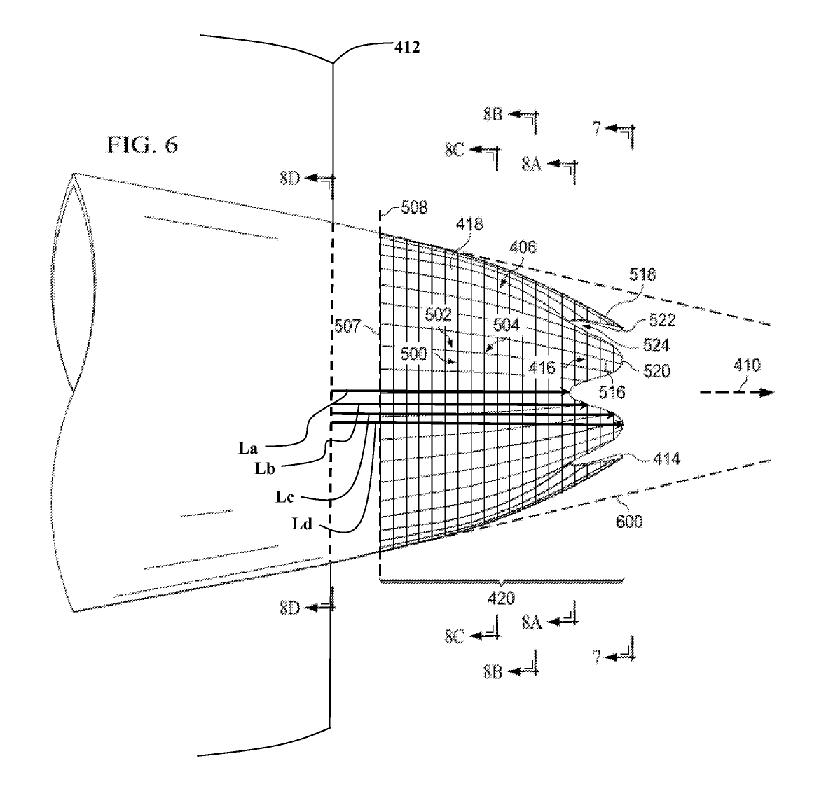

With reference now to FIG. 6, an illustration of a side view of core nozzle 406 of nozzle system 403 is depicted in accordance with an illustrative embodiment. As illustrated, all curves in plurality of curves 506 begin at selected axial plane 508.

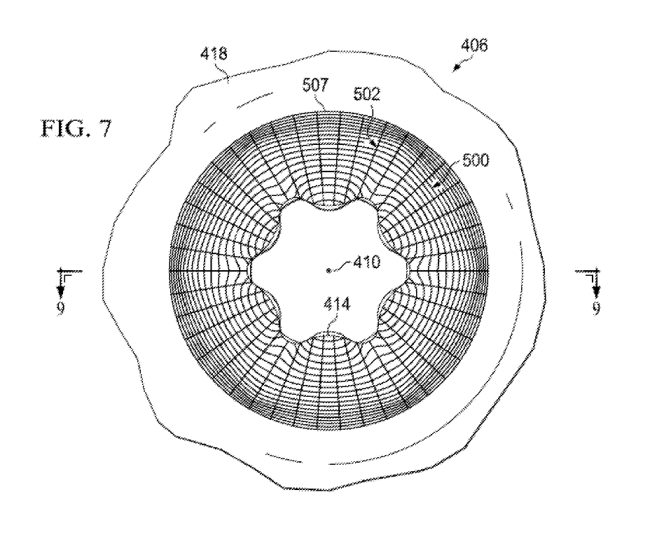

Turning now to FIG. 7, an illustration of an end view of core nozzle 406 is depicted in accordance with an illustrative embodiment. In this illustrative example, an end view of core nozzle 406 taken with respect to lines 7-7 in FIG. 6 is depicted. As illustrated, outer surface 418 along any axial plane through aft portion 420 of core nozzle 406 has a wavy shape.

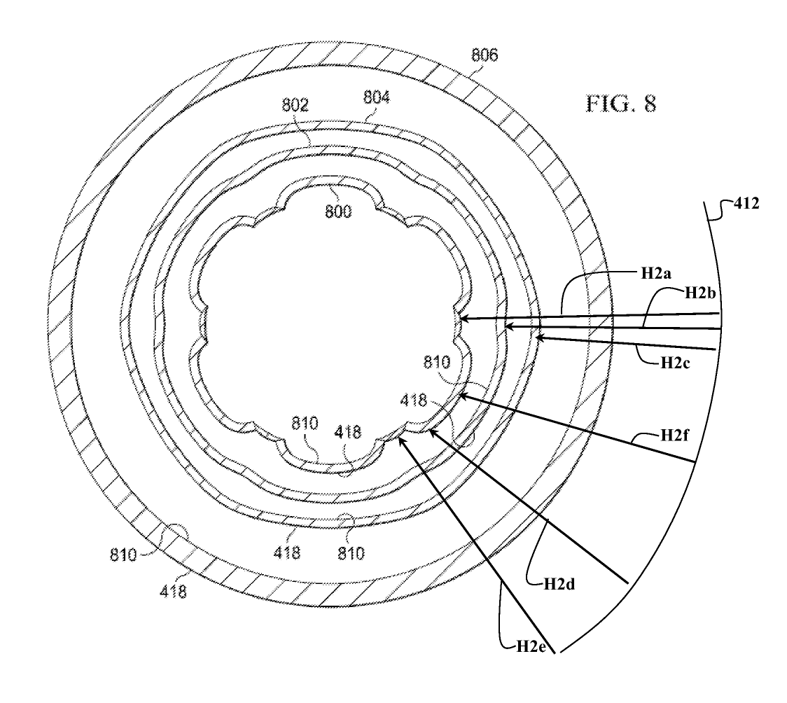

With reference now to FIG. 8, an illustration of axial cross-sections through core nozzle 406 is depicted in accordance with an illustrative embodiment. In this illustrative example, axial cross-section 800 of core nozzle 406 is a cross-section along an axial plane through core nozzle 406 taken along lines 8A-8A in FIG. 6. Further, axial cross-section 802 is a cross-section along an axial plane through core nozzle 406 taken along lines 8B-8B in FIG. 6. Axial cross-section 804 is a cross-section along an axial plane through core nozzle 406 taken along lines 8C-18 in FIG. 6. Axial cross-section 806 is a cross-section along an axial plane through core nozzle 406 taken along lines 8D-8D in FIG. 6 substantially coplanar with the trailing edge 412 of the fan nozzle 404 forming the exit plane.

In this illustrative example, outer surface 418 of core nozzle 406 has a wavy shape in axial cross-section 800, axial cross-section 802, and axial cross-section 804. However, outer surface 418 of core nozzle 406 is substantially symmetrical and circular in axial cross-section 806.

In this illustrative example, inner surface 810 of core nozzle 406 is depicted in axial cross-section 800, axial cross-section 802, and axial cross-section 804. Although inner surface 810 of core nozzle 406 is depicted as having a shape similar to outer surface 418, inner surface 810 may have some other suitable shape in other illustrative examples. For example, in some cases, inner surface 810 may be substantially circular in each of axial cross-section 800, axial cross-section 802, axial cross-section 804, and axial cross-section 806.

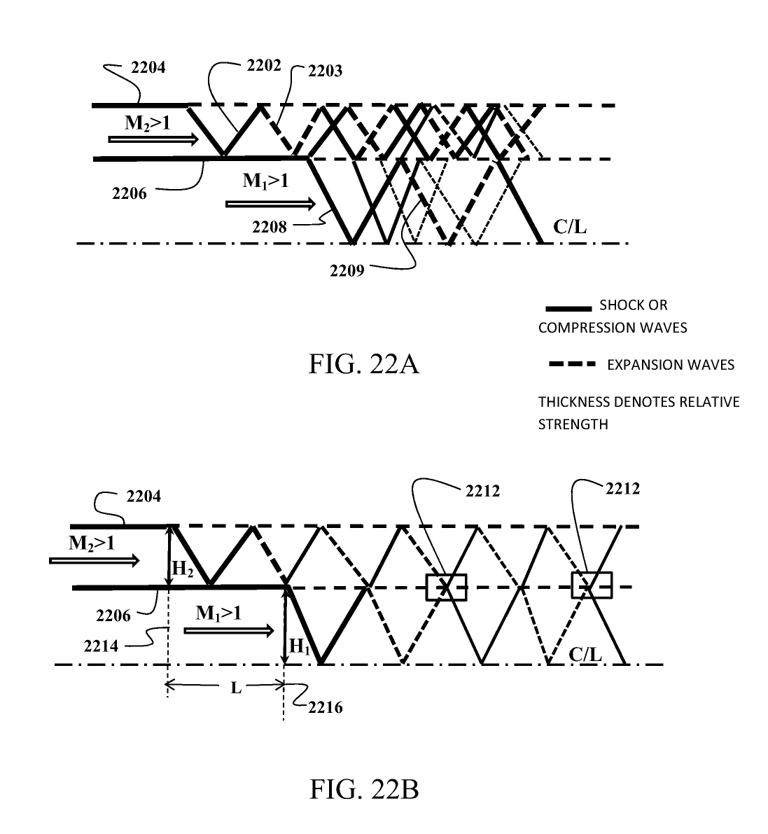

As shown in FIG. 22A, shock waves or compression waves 2202 (depicted as solid lines with width of the line indicating relative strength) and expansion waves 2203 (depicted as dashed lines again with width of the line indicating relative strength) are generated by flow exiting a fan nozzle 2204 and interacting with a core nozzle 2206. Similarly, shock waves or compression waves 2208 and expansion waves 2209 are generated by flow exiting the core nozzle 2206. FIG. 22A depicts the complex shock cell pattern in both streams before cancellation due to the generation at the exit plane and downstream reflection and refraction of the shockwaves and expansion waves. FIG. 22A shows one exemplary condition with over expanded flow for fan nozzle and imperfectly expanded core nozzle flow.

FIG. 22B demonstrates a simplified shock cell pattern created by weakening the core lip shock wave in the fan flow, as well as alternate cancellations (at junctures shown by the rectangles 2212) which are created by adjustment of the annular height H2 between the fan nozzle 2204 and core nozzle 2206 at an exit plane 2214 (established for example by trailing edge 412 in FIG. 4), a radius of the core nozzle H1 at a second exit plane 2216 and a distance between the exit planes L. The exemplary condition shown in FIG. 22B is representative of a fixed configuration of the fan nozzle and core nozzle with H1, H2 and L optimized for cancellation at a particular operating condition of the engine (for example engine 400). Operation for under expanded flow is comparable.

Reduction of shock cell noise is accommodated by the embodiments disclosed herein for a range of operating conditions of the engine by the combination of longitudinal curves 514 in the surface of the core nozzle 406 as described with respect to FIG. 5. The longitudinal curves vary in radial planes as previously defined with respect to FIG. 2, (the plane formed by one of the radial axes and center axis 200). The varying longitudinal curvature of the longitudinal lines, for example curve 514, alters the effective annular radius H2 between fan nozzle and the core nozzle as illustrated by radii H2a, H2b and H2c in FIG. 8 (offset azimuthally for clarity) and the extensions 416 varying the distances L of the effect exit planes between the tips, for example tips 520 and 522, and roots, for example root 524. The wavy surface created by the curves 510 alters H2 around the circumference of the core nozzle (azimuthally) as represented by radii H2d, H2e and H2f in FIG. 8. L is varied along the extent of each extension 416 as illustrated by curves La, Lb, Lc and Ld in FIG. 6. While ideal cancellation is not achieved at all positions around the circumference of the nozzle system 403, each curve 514 and each extension 416 creates a smooth variation in H2 and L, respectively, which will provide shock cell cancellation around at least segmented portions of the circumference at each operating condition in a range established by the total variation in H2 and L thereby reducing the total shock cell noise.

In an exemplary embodiment in which a plug 408 is employed within the core nozzle, the surface of the plug is shaped in a manner similar to the outer surface 418 of the core nozzle to create an effective radial distance relative to the plug 408 and variation in distance from the effective core nozzle exit plane created by the extensions 416 to the plug tip may provide similar shock cell cancellation from core lip and the plug tip.

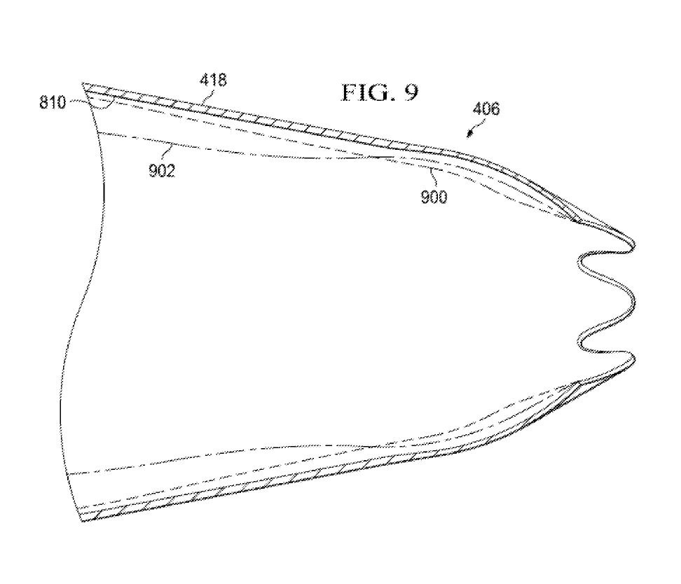

With reference now to FIG. 9, an illustration of a cross-sectional view of core nozzle 406 is depicted in accordance with an illustrative embodiment. In this illustrative example, a cross-sectional view of core nozzle 406 taken along lines 9-9 in FIG. 7 is depicted.

Inner surface 810 of core nozzle 406 is seen in this cross-sectional view. Although inner surface 810 of core nozzle 406 is depicted as curving in a manner similar to outer surface 418, inner surface 810 may curve in some other suitable manner, or in some cases, not curve.

For example, in some illustrative examples, core nozzle 406 may have alternate inner surface 900 instead of inner surface 810. In other illustrative examples, core nozzle 406 may have alternate inner surface 902 instead of inner surface 810.

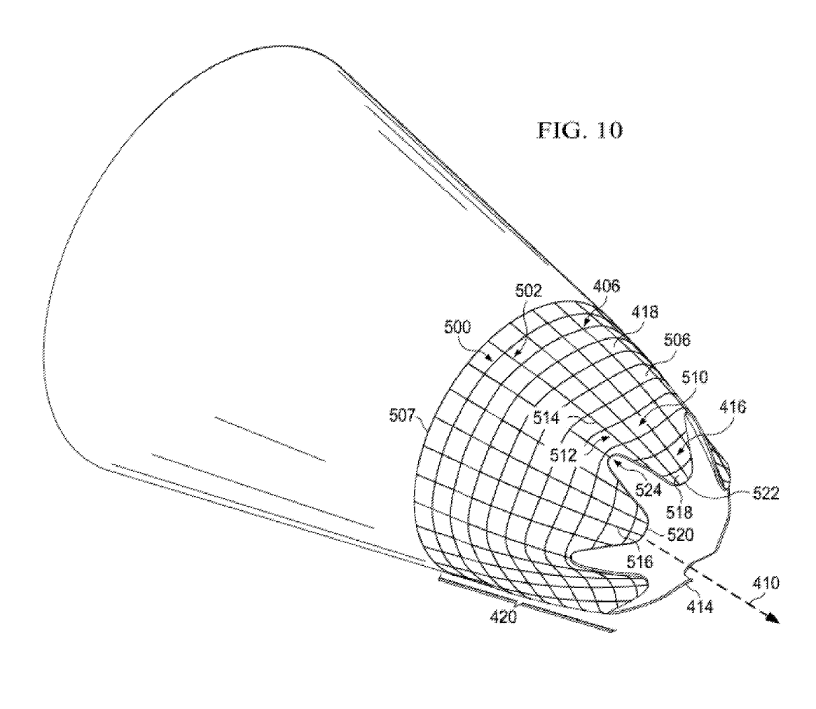

With reference now to FIG. 10, an illustration of another configuration for core nozzle 406 is depicted in accordance with an illustrative embodiment. In this illustrative example, outer surface 418 of aft portion 420 of core nozzle 406 in FIG. 10 has a different shape than outer surface 418 of aft portion 420 of core nozzle 406 in FIGS. 4-9. In particular, outer surface 418 of aft portion 420 of core nozzle 406 in FIG. 10 is curved in a manner that is different from the curving of outer surface 418 of aft portion 420 of core nozzle 406 in FIGS. 4-9. For example, plurality of curves 504 along the different radial planes through core nozzle 406 in FIG. 10 have different curvatures than plurality of curves 504 in FIG. 5.

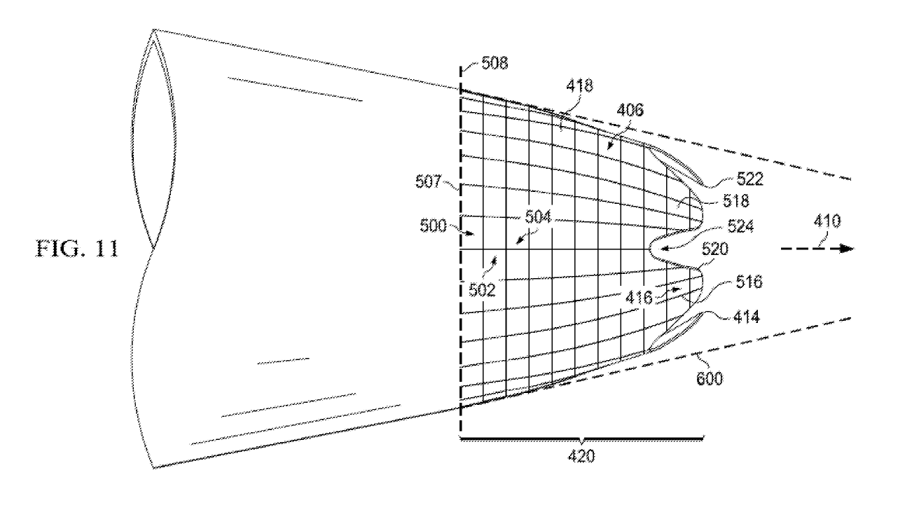

Turning now to FIG. 11, an illustration of a side view of core nozzle 406 is depicted in accordance with an illustrative embodiment. In this illustrative example, a side view of core nozzle 406 from FIG. 10 is depicted.

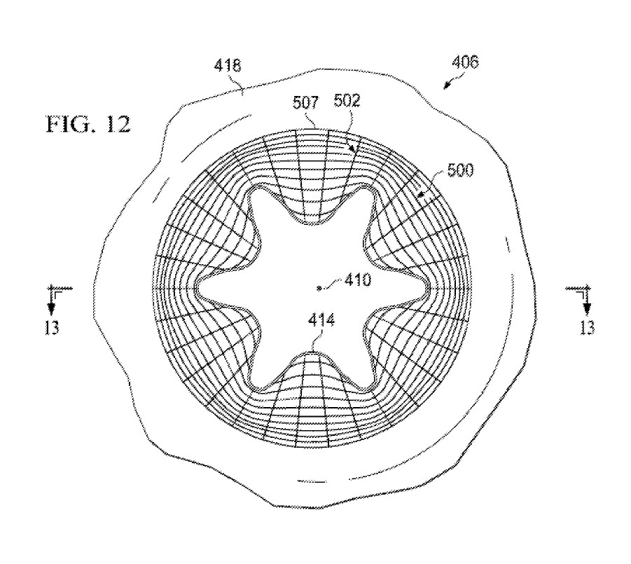

Referring now to FIG. 12, an illustration of an end view of core nozzle 406 is depicted in accordance with an illustrative embodiment. In particular, an end view of core nozzle 406 from FIG. 10 taken along lines 12-12 is depicted.

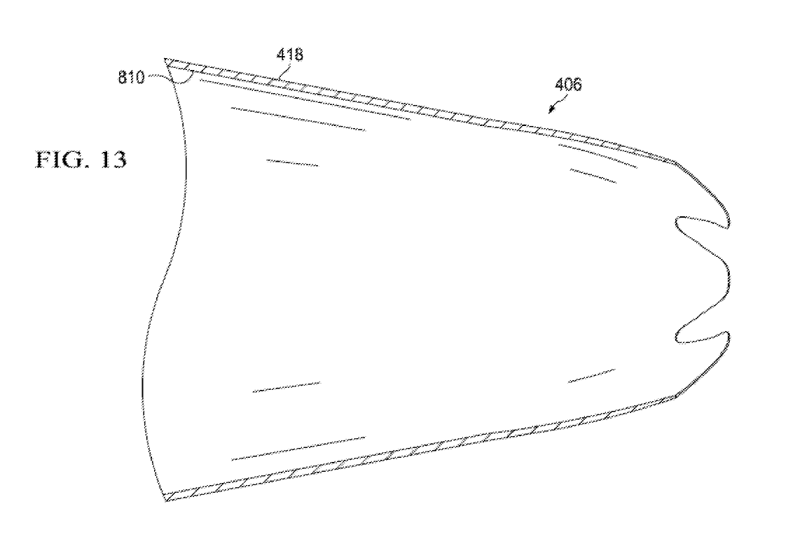

With reference now to FIG. 13, an illustration of a cross-sectional view of core nozzle 406 is depicted in accordance with an illustrative embodiment. In this illustrative example, a cross-sectional view of core nozzle 406 from FIG. 10 is depicted taken along lines 13-13 in FIG. 12.

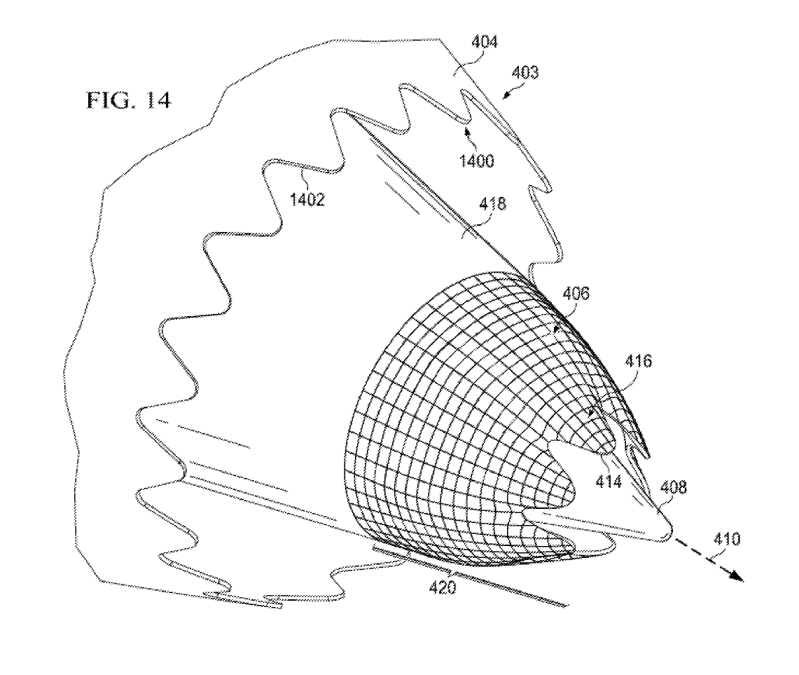

With reference now to FIG. 14, an illustration of a portion of nozzle system 403 is depicted in accordance with an illustrative embodiment. In this illustrative example, fan nozzle 404 of nozzle system 403 is depicted having plurality of extensions 1400. With plurality of extensions 1400, fan nozzle 404 has trailing edge 1402 instead of trailing edge 412 in FIG. 4. Plurality of extensions 1400 may be configured to help reduce noise generated by engine 400.

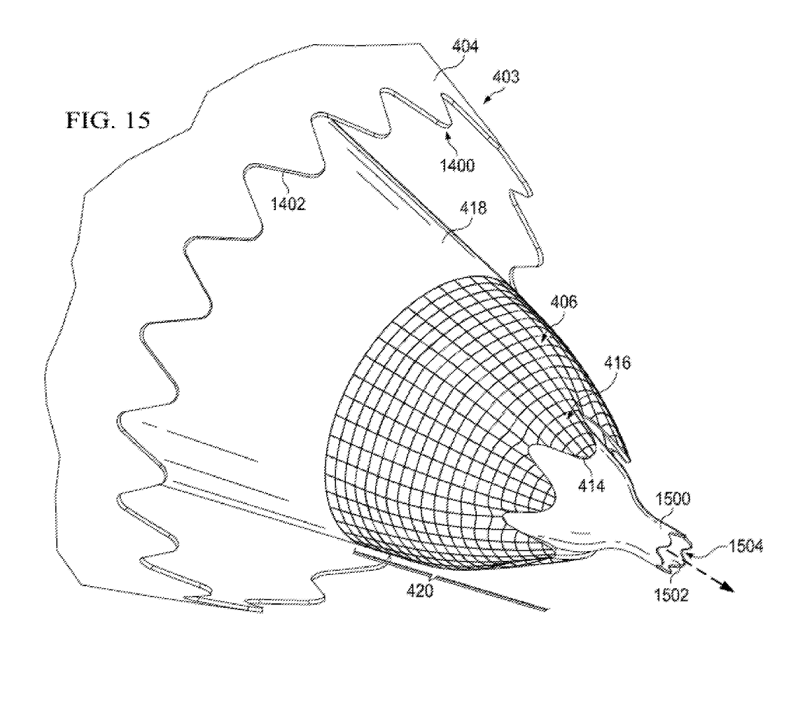

As previously described with respect to FIG. 22B, the shape of extensions 1400 may also be employed to vary the effective distance L between the fan nozzle exit plane and the core nozzle exit plane around the circumference of the nozzle system 403. Shaping of extensions 1400 may thereby additionally contribute to the range of L as depicted by Le, Lf, Lg and Lh in FIG. 16 for desired shock cell cancellation. Extensions 1400 may additionally extend over at least a part of the aft portion 420 of the core nozzle. Turning now to FIG. 15, an illustration of a portion of nozzle system 403 with a plug having a channel is depicted in accordance with an illustrative embodiment. In this illustrative example, nozzle system 403 uses fan nozzle 404 having plurality of extensions from FIG. 14. Further, nozzle system 403 uses plug 1500 instead of plug 408 from FIG. 4. As depicted, plug 1500 has channel 1502 configured to vent gases. Further, plug 1500 has plurality of extensions 1504.

With reference now to FIG. 16, an illustration of a side view of a portion of nozzle system 403 with plug 1500 having channel 1502 is depicted in accordance with an illustrative embodiment. As depicted, outer surface 1600 of aft portion 1602 of plug 1500 is not curved.

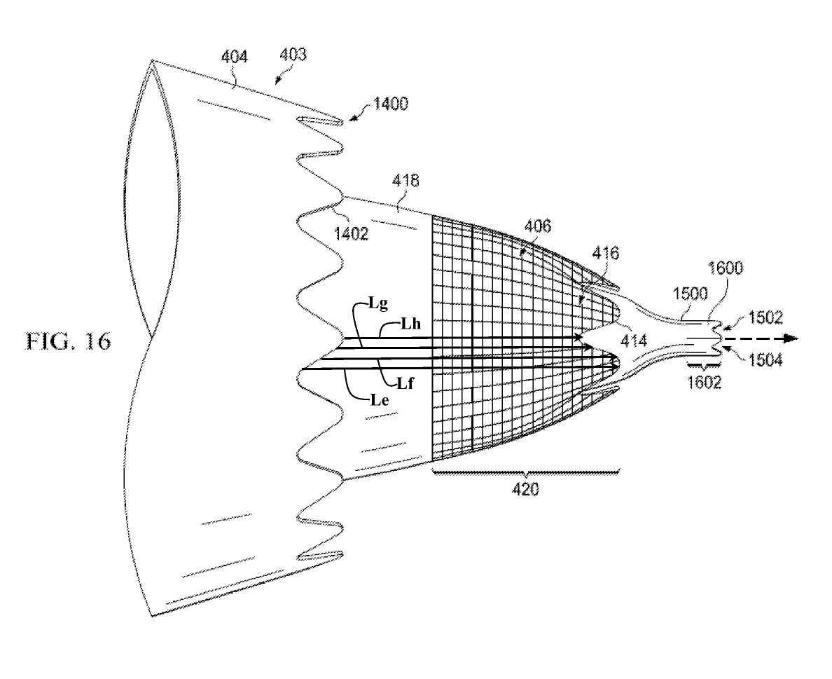

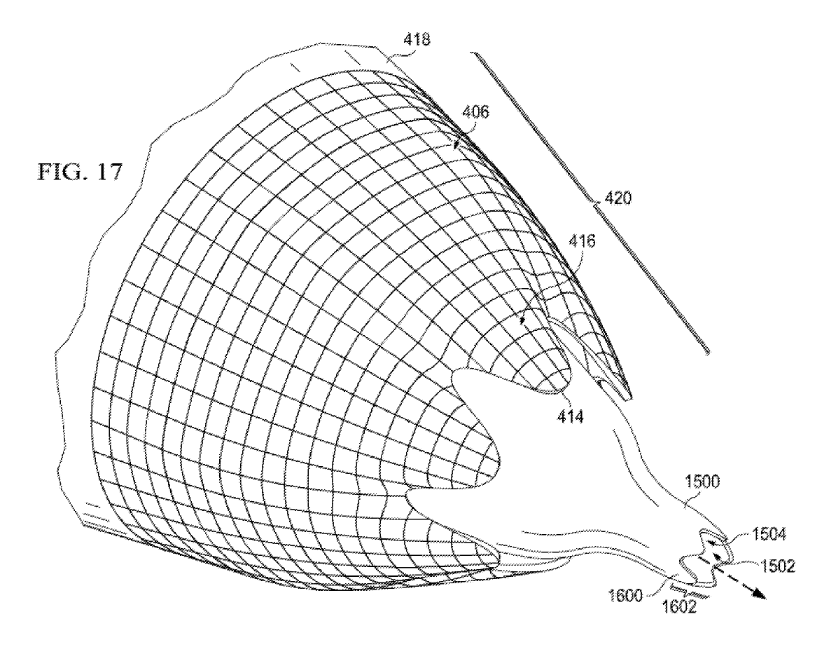

With reference now to FIG. 17, an illustration of a portion of nozzle system 403 with plug 1500 having channel 1502 is depicted in accordance with an illustrative example. In this illustrative example, outer surface 1600 of aft portion 1602 of plug 1500 is curved along a plurality of longitudinal lines through center axis 410. The shape of aft portion 1602 of plug 1500 may be a shape similar to the shape of core nozzle 406 in FIGS. 4 and 5. This configuration for plug 1500 may help reduce shock-cell noise when the jet stream between core nozzle 406 and plug 1500 is supersonic.

Turning now to FIG. 18, an illustration of a side view of nozzle system 403 with plug 1500 having channel 1502 is depicted in accordance with an illustrative example. As depicted, nozzle system 403 in FIG. 17, with plug 1500 having channel 1502 and with outer surface 1600 of aft portion 1602 curved, is depicted.

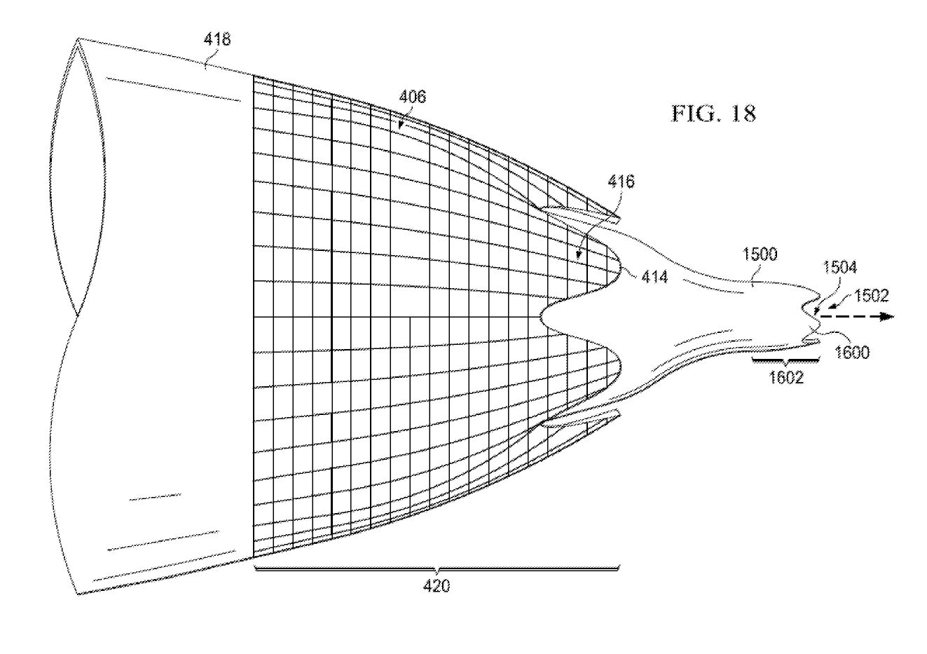

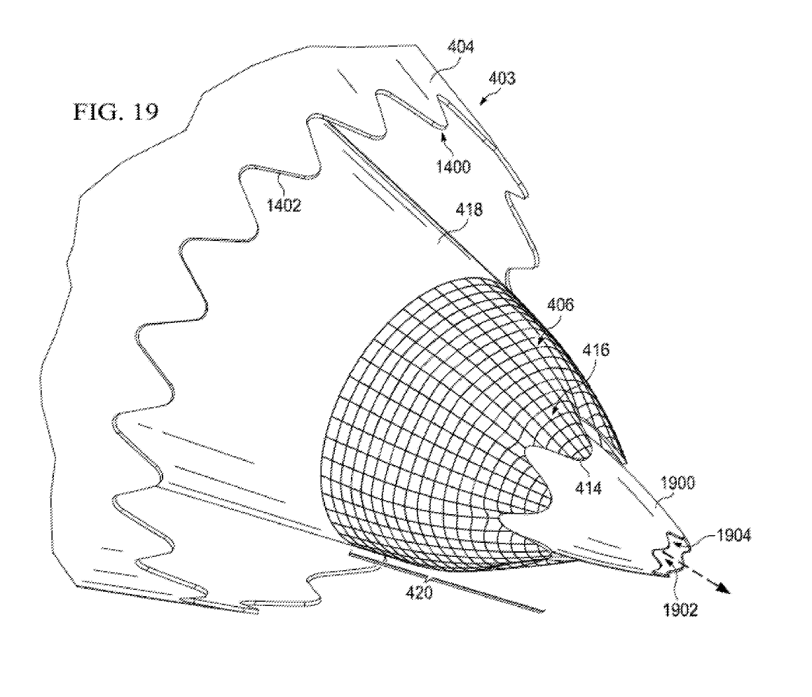

With reference now to FIG. 19, an illustration of a portion of nozzle system 403 with a plug having a different shape is depicted in accordance with an illustrative embodiment. In this illustrative example, nozzle system 403 uses plug 1900 instead of plug 1500 in FIGS. 15-18 or plug 408 in FIG. 4. Plug 1900 has channel 1902 and plurality of extensions 1904.

The illustrations of the different configurations for fan nozzle 404, core nozzle 406, and plug 408 of nozzle system 403 in FIGS. 4-18 and plug 1900 in FIG. 19 are not meant to imply physical or architectural limitations to the manner in which an illustrative embodiment may be implemented. Other components in addition to or in place of the ones illustrated may be used. Some components may be unnecessary.

For example, although core nozzle 406 has been depicted as extending aftwards past trailing edge 412 of fan nozzle 404, fan nozzle 404 may extend aftwards past trailing edge 414 of core nozzle 406 in some illustrative examples. Of course, in other illustrative examples, a plug may be optional for nozzle system 403.

Further, the different components shown in FIGS. 4-19 may be combined with components in FIG. 1, used with components in FIG. 1, or a combination of the two. Additionally, some of the components in these figures may be illustrative examples of how components shown in block form in FIG. 1 can be implemented as physical structures.

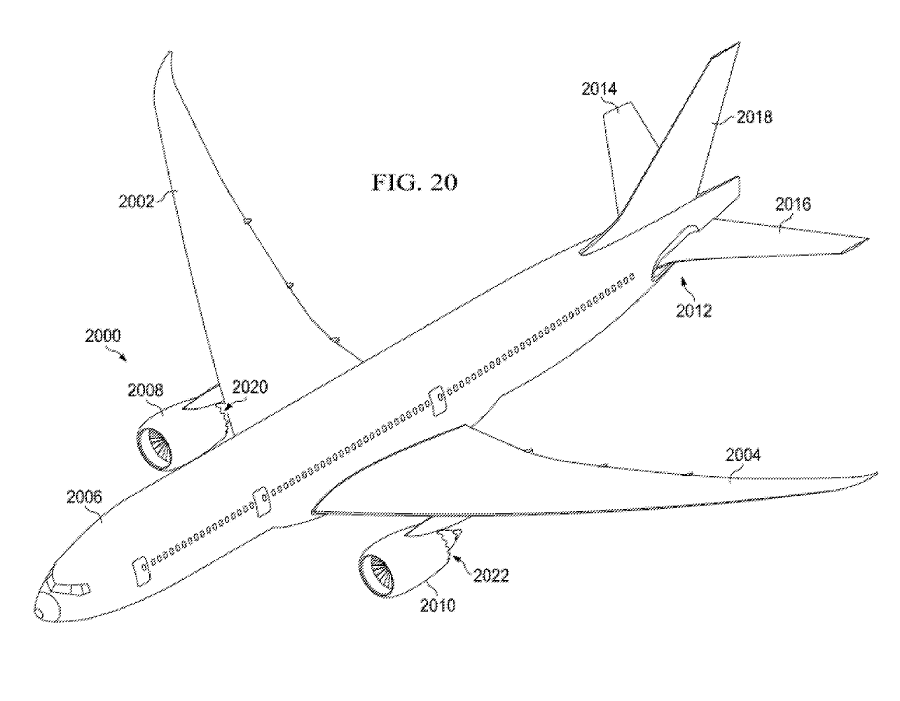

With reference now to FIG. 20, an illustration of an aircraft is depicted in accordance with an illustrative embodiment. In this illustrative example, aircraft 2000 is an example of one implementation for aerospace vehicle 105 in FIG. 1. Aircraft 2000 has wing 2002 and wing 2004 attached to body 2006.

Aircraft 2000 includes engine 2008 attached to wing 2002 and engine 2010 attached to wing 2004. Engine 2008 and engine 2010 may be examples of one implementation for engine 102 in FIG. 1. Body 2006 of aircraft 2000 has tail section 2012. Horizontal stabilizer 2014, horizontal stabilizer 2016, and vertical stabilizer 2018 are attached to tail section 2012 of body 2006.

In this illustrative example, engine 2008 has nozzle system 2020, and engine 2010 has nozzle system 2022. Nozzle system 2020 and nozzle system 2022 may have the same configuration as nozzle system 403 in FIG. 14 with fan nozzle 404 having plurality of extensions 1400, core nozzle 406 having outer surface 418 of aft portion 420 of core nozzle 406 curved, and plug 408.

With reference now to FIG. 21, an illustration of a process for reducing noise generated by an engine in the form of a flowchart is depicted in accordance with an illustrative embodiment. The process illustrated in FIG. 21 may be implemented using nozzle system 100 for engine 102 in FIG. 1 and/or the different configurations for nozzle system 403 described in FIGS. 4-19.

The process begins by operating an engine (operation 2100). The engine comprises a first nozzle and a second nozzle. The second nozzle is at least partially surrounded by the first nozzle. An outer surface of an aft portion of the second nozzle has a shape configured such that a radial cross-section of the outer surface of the aft portion of the second nozzle has a curve that is different from at least one other curve for another radial cross-section of the outer surface of the aft portion of the second nozzle.

In operation 2100, the engine may generate exhaust that exits the nozzle system as an exhaust jet. The exhaust jet comprises a first jet stream that exits the first nozzle and a second jet stream that exits the second nozzle. The first jet stream may exit the first nozzle at a first supersonic speed and the second jet stream may exit the second nozzle at one of a second supersonic speed or a subsonic speed.

The process then reduces noise generated during operation of the engine using the second nozzle of the nozzle system (operation 2101), with the process terminating thereafter. In operation 2102, the shape of the outer surface of the aft portion of the second nozzle is selected to reduce shock-cell noise associated with a shock-cell pattern that forms in the first jet stream when the first jet stream exits the nozzle system at supersonic speeds.

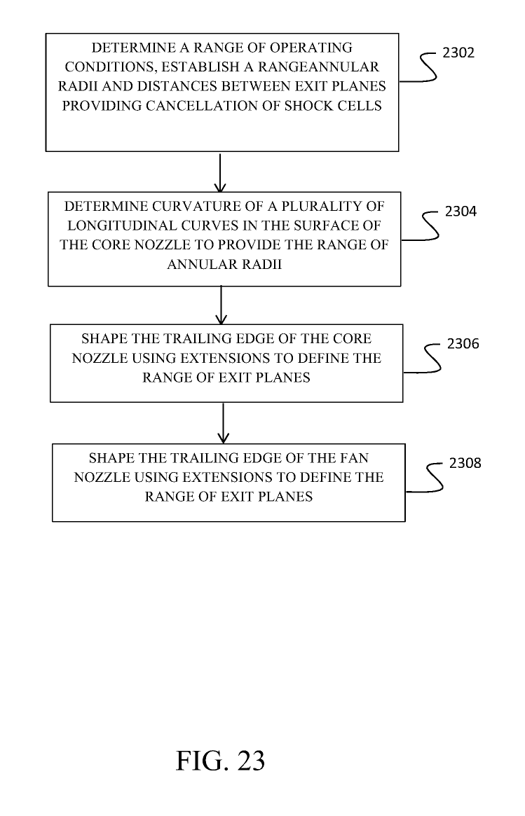

Referring to FIG. 23, shock cell cancellation may be obtained over a range of operating conditions in an engine having a nozzle system 403 by determining the desired range of operating conditions and establishing a range of annular radii, H2, between the fan nozzle 404 and core nozzle 406, and distances between exit planes L that provide cancellation of shock cells for the operating range, step 2302. Curvature of a plurality of curves 514 in the surface 418 of the core nozzle 406 is determined to provide the range of annular radii, H2, step 2304. Shaping of the trailing edge of the core nozzle using tip extensions (for example tip extensions 520, 522) is determined to define the range of exit plane distances, L, step 2306. The curves 510 may establish a wavy circumferential shape as previously described. Shaping of the trailing edge of the fan nozzle 404 using extensions 1400 may additionally or alternatively be determined to alter the range of exit plane distances, step 2308.

The flowcharts and block diagram in the different depicted embodiments illustrate the architecture, functionality, and operation of some possible implementations of apparatuses and methods in an illustrative embodiment. In this regard, each block in the flowchart or block diagram may represent a module, segment, function, and/or a portion of an operation or step. For example, one or more of the blocks may be implemented as program code, in hardware, or a combination of the program code and hardware.

In some alternative implementations of an illustrative embodiment, the function or functions noted in the blocks may occur out of the order noted in the figures. For example, in some cases, two blocks shown in succession may be executed substantially concurrently or the blocks may sometimes be performed in the reverse order, depending upon the functionality involved. Also, other blocks may be added in addition to the illustrated blocks in a flowchart or block diagram.

Thus, the different illustrative embodiments provide a method and apparatus for reducing noise generating during operation of a propulsion system. In one illustrative embodiment, an apparatus comprises a first nozzle and a second nozzle at least partially surrounded by the first nozzle. An outer surface of an aft portion of the second nozzle has a shape configured such that a radial cross-section of the outer surface of the aft portion of the second nozzle has a curve that is different from at least one other curve for another radial cross-section of the outer surface of the aft portion of the second nozzle.

The description of the different illustrative embodiments has been presented for purposes of illustration and description and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for shock cell noise reduction comprising:
determining the desired range of operating conditions for an engine having a nozzle system with a fan nozzle and a core nozzle;
establishing for a core nozzle radii, H1, and a range of distances between exit planes, L, and a range of annular radii H2 between the fan nozzle and core nozzle, that provide cancellation of shock cells for the range of operating conditions;
determining curvature of a plurality of curves in a surface of the core nozzle to provide the range of annular radii, H2; and,
shaping a trailing edge of the core nozzle using extensions to define the range of effective exit plane distances, L.

2. The method for shock cell noise reduction as defined in claim 1 wherein the curves establish a wavy circumferential shape in the core nozzle surface.

3. The method for shock cell noise reduction as defined in claim 1 further comprising:
shaping a trailing edge of the fan nozzle using extensions to alter the range of exit plane distances, L.

4. The method for shock cell noise reduction as defined in claim 1 further comprising:
determining curvature of a plurality of curves on an inner surface of the fan nozzle to alter the annular radius H2 over a range to provide additional matching adjustment of H2, H1 and L to provide shock cell cancellation over the operating range.

5. A nozzle system for shock cell noise reduction comprising:
a fan nozzle;
a core nozzle concentric with the fan nozzle and having
a plurality of curves in a surface of the core nozzle altering the effective annular radius H2 between the fan nozzle and core nozzle over a first range and
a plurality of circumferential extensions on a trailing edge of the core nozzle varying a distance, L, between an exit plane of the fan nozzle and an exit plane of the core nozzle between tips and roots of each extension over a second range, said first range of H2 and second range of L determined to establish cancellation of shock cells for a range of operating conditions of an engine.

6. The nozzle system as defined in claim 5 wherein the curves establish a wavy circumferential shape in the core nozzle surface.

7. The nozzle system as defined in claim 5 wherein each curve and each extension creates a smooth variation in H2 and L providing cancellation of shock cells around at least segmented portions of a circumference of the nozzle system at each operating condition in the operating range of the engine in a range established by the total variation in H2 and L.

8. The nozzle system as defined in claim 7 further comprising:
a plurality of extensions on a trailing edge of the fan nozzle employed to vary the effective distance, L, between the fan nozzle exit plane and the core nozzle exit plane around the circumference of the nozzle system.

9. The nozzle system as defined in claim 8 further wherein the plurality of extensions on the trailing edge of the fan nozzle extend over at least a part of the aft portion of the core nozzle to vary the effective annular radius H2.

10. The nozzle system as defined in claim 5 wherein each of the plurality of curves reside on a radial cross-section of an outer surface of an aft portion of the core nozzle and begin at a selected axial plane through the core nozzle and end at the trailing edge of the core nozzle.

11. The nozzle system as defined in claim 9 wherein each of the plurality of curves for the radial cross-section of the outer surface of the aft portion of the core nozzle has a curvature that continuously changes between a selected axial plane through the core nozzle and a trailing edge of the core nozzle.

12. The nozzle system as defined in claim 5 further comprising a plug located within the core nozzle, said effective radius, H1, of the core nozzle extending between an inner surface of the core nozzle and the plug.

13. The nozzle system as defined in claim 11 wherein the plug comprises a channel configured to vent gases.

14. The nozzle system as defined in claim 12 wherein the plug further comprises a plurality of extensions at an aft end of the plug.

15. The nozzle system as defined in claim 5 wherein the plurality of extensions on the core nozzle are chevrons or serrations.

16. The nozzle system as defined in claim 8 wherein the plurality of extensions on the fan nozzle are chevrons or serrations.

17. An engine comprising:
a housing; and
a nozzle system at an aft end of the housing, the nozzle system having
a fan nozzle;
a core nozzle concentric with the fan nozzle and having
a plurality of curves in a surface of the core nozzle altering the effective annular radius between the fan nozzle and the core nozzle, H2, over a first range and
a plurality of circumferential extensions on a trailing edge of the core nozzle varying a distance, L, between an exit plane of the fan nozzle and an exit plane of the core nozzle between tips and roots of each extension over a second range, said first range of H2 and second range of L determined to establish cancellation of shock cells for a range of operating conditions of the engine.

18. The engine as defined in claim 16 wherein each curve and each tip creates a smooth variation in H2 and L providing cancellation of shock cells around at least segmented portions of a circumference of the nozzle system at each operating condition in the operating range of the engine in a range established by the total variation in H2 and L.

19. The engine as defined in claim 17 further comprising:
a plurality of extensions on a trailing edge of the fan nozzle employed to vary the effective distance, L, between the fan nozzle exit plane and the core nozzle exit plane around the circumference of the nozzle system.

20. The engine as defined in claim 16 wherein each of the plurality of curves reside on a radial cross-section of an outer surface of an aft portion of the core nozzle and begin at a selected axial plane through the core nozzle and end at the trailing edge of the core nozzle.
